(19) United States
(12) Patent Application Publication
(10) Pub. No.: US 2023/0012534 A1
(43) Pub. Date: Jan. 19, 2023

(54) OPTICAL ARRANGEMENT AND LASER SYSTEM

(71) Applicant: TRUMPF Laser- und Systemtechnik GmbH, Ditzingen (DE)

(72) Inventors: Thomas Zeller, Sindelfingen (DE); Christoph Tillkorn, Villingendorf (DE); Julian Hellstern, Rottweil (DE); Andreas Heimes, Renningen (DE); Christian Lingel, Kernen im Remstal (DE); Christoph Irion, Stuttgart (DE)

(21) Appl. No.: 17/948,299

(22) Filed: Sep. 20, 2022

Related U.S. Application Data
(63) Continuation of application No. PCT/EP2021/057416, filed on Mar. 23, 2021.

(30) Foreign Application Priority Data
Mar. 30, 2020 (DE) 10 2020 108 647.4

(51) Int. Cl. G02B 27/09; B23K 26/073

(52) U.S. Cl. CPC G02B 27/0966; G02B 27/0927; G02B 27/0961; G02B 27/0905; B23K 26/0738

(57) ABSTRACT

An optical arrangement is provided for converting an input laser beam into a linear output beam propagating along a propagation direction and having in a working plane and a linear beam cross section extending along a line direction and having a non-vanishing intensity. The optical arrangement includes a reshaping optical unit having an input aperture for receiving the input laser beam and an output aperture, and is configured to convert the input laser bean into a beam packet having a multiplicity of beam segments that emerges through the output aperture. In addition, a homogenization optical unit is included having a first lens array and a second lens array arranged downstream of the first lens array in the beam path, the homogenization optical unit configured to mix different beam segments of the beam packet along the line direction. A transformation lens is configured such to superpose the mixed beam segments so as to form the linear output beam, and a displacement device is configured to displace the second lens array relative to the first lens array.

### CROSS REFERENCE TO RELATED APPLICATIONS

This application is a continuation of International Application No. PCT/EP2021/057416 (WO 2021/197923), filed on Mar. 23, 2021, and claims benefit to German Patent Application No. DE 10 2020 108 647.4, filed on Mar. 30, 2020. The aforementioned applications are hereby incorporated by reference herein.

### FIELD

The invention relates to an optical arrangement for converting an input laser beam into a linear output beam, and to a laser system comprising such an optical arrangement.

### BACKGROUND

Such laser systems serve to generate in particular high-intensity radiation having an intensity distribution that has a linearly extending beam cross section. The axis defined by the linear extent will be referred to in the following text as the “long axis” of the intensity distribution. An axis perpendicular to the linear extent and perpendicular to the propagation direction will also be referred to as the “short axis.” For the description of the geometric relationships of the beam, in each case a local coordinate system should be assumed, wherein the long axis (x), the short axis (y) and the propagation direction (z) define an oriented, right-handed Cartesian coordinate system.

The linear beam profiles mentioned are used for example to process surfaces of glasses or semiconductors (for example tempering, annealing). The linear beam profile is scanned here substantially perpendicular to the long axis over the surface to be processed. With the radiation, for example recrystallization processes, surface melts, diffusion processes of foreign materials into the material to be treated, or other phase conversions in the region of the surface can be triggered. Such processing processes are used, for example, in the production of TFT displays, in the doping of semiconductors, in the production of solar cells, but also in the production of esthetically designed glass surfaces for construction purposes.

An optical arrangement having the features of the preamble of claim 1 is described in WO 2018/019374 A1.

It is important for the aforementioned processing processes that the intensity profile along the long axis has a substantially constant intensity profile that is as homogeneous as possible, and the intensity profile along the short axis satisfies corresponding quality requirements. In practice, however, the intensity profile has regularly local inhomogeneities in the intensity profile that are caused, for example, by interference artifacts (for example regular diffraction patterns), and/or defects and form errors of optical units (for example aberrations), and/or contaminations of optical units due to particles (lead to shadows cast on the working plane).

To reduce interference artifacts, it is known to periodically move a position of the laser beam back and forth along the long axis by means of mirrors and in this way to smooth any disruptive influence on the intensity profile averaged over time. A corresponding optical arrangement is described, for example, in US 2011/0097906 A1.

### SUMMARY

In an embodiment, the present disclosure provides an optical arrangement for converting an input laser beam into a linear output beam propagating along a propagation direction and having in a working plane and a linear beam cross section extending along a line direction and having a non-vanishing intensity. The optical arrangement includes a reshaping optical unit having an input aperture for receiving the input laser beam and an output aperture, and is configured to convert the input laser bean into a beam packet having a multiplicity of beam segments that emerges through the output aperture. In addition, a homogenization optical unit is included having a first lens array and a second lens array arranged downstream of the first lens array in the beam path, the homogenization optical unit configured to mix different beam segments of the beam packet along the line direction. A transformation lens is configured such to superpose the mixed beam segments so as to form the linear output beam, and a displacement device is configured to displace the second lens array relative to the first lens array.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a diagram for illustrating the beam path in a laser system to produce linear intensity distributions;

FIG. 2 shows a diagram for illustrating the effect of the homogenization optical unit and of the transformation lens means;

FIG. 3 shows a diagram for illustrating the beam path at the homogenization optical unit and the transformation lens means for a displacement of the second lens array in relation to the first lens array; and

FIG. 4 shows a diagrammatic illustration of a preferred configuration of a displacement device in a perspective view.

### DETAILED DESCRIPTION

An aspect of the present invention is concerned with providing an intensity profile that is as homogeneous as possible.

In an embodiment, the present invention provides an optical arrangement including an apparatus for converting an input laser beam into an output beam having a linear intensity profile. In this respect, the output beam propagates (averaged with respect to space) in a propagation direction and has an intensity distribution that has, in an optical working plane of the optical arrangement, a beam cross section with a linear profile along a direction that is designated “line direction” in the present context. Since the beam can be deflected once or multiple times, depending on the configuration, as it passes through the optical arrangement, the line direction should be understood to mean that the beam cross section is elongated locally along the line direction.

The optical arrangement comprises a reshaping optical unit having an input aperture, through which the input laser beam can be radiated in, and an output aperture. The output aperture extends in particular longitudinally along an output aperture longitudinal direction. The dimension of the output aperture along the output aperture longitudinal direction is in particular significantly greater than the dimension perpendicular to the output aperture longitudinal direction.

The reshaping optical unit is configured such that the input laser beam radiated in through the input aperture is converted into a beam packet that exits through the output aperture. In particular, the beam packet forms in a theoretical viewing plane downstream of the output aperture overall already an elongate intensity distribution, in particular already with a substantially linear character. The beam packet comprises a multiplicity of beam segments which distribute themselves in particular over the preferably elongate output aperture and preferably completely fill the output aperture.

In the present context, a beam packet designates in particular a light distribution that can be mathematically described by a vector field, wherein each spatial point is locally assigned the Poynting vector of the associated electromagnetic field.

The reshaping optical unit is in particular designed to produce from a largely coherent input laser beam a beam packet that has a reduced spatial coherence or is even substantially incoherent.

The optical arrangement additionally comprises a homogenization optical unit, which is designed to superpose and mix different beam segments of the beam packet along the line direction in a manner such that the intensity profile is homogenized with respect to the direction in which the beam cross section extends in an elongate manner.

The homogenization optical unit comprises a first lens array and a second lens array arranged downstream of the first lens array in the beam path. A lens array in the present context designates in particular an arrangement of a plurality of lenses. The arrangement of the lenses can be irregular, or the lenses can be arranged in a regular pattern one next to the other.

The optical arrangement furthermore comprises a transformation lens means that is arranged in the beam path downstream of the homogenization optical unit. The transformation lens means is designed such that the mixed beam segments are superposed and homogenized to form the linear output beam. In this respect, the transformation lens means in particular also contributes to the homogenization. For this purpose, for example, the working plane can extend in a focus region of the transformation lens means. It is conceivable, for example, that, from each region of the captured radiation, beam segments are focused into different, preferably all, regions along the line direction.

The optical arrangement furthermore comprises a displacement device, which is designed to displace the second lens array of the homogenization optical unit in relation to the first lens array of the homogenization optical unit.

A displacement of the second lens array in relation to the first lens array brings about, among other things, a change in the intensity distribution of the (mixed) beam packet emerging from the homogenization optical unit (in the following text, the mixed beam packet emerging from the homogenization optical unit will also be designated “intermediate beam packet”). In particular, a displacement of the second lens array in relation to the first lens array brings about a change in the angle distribution of the beam segments of the intermediate beam packet and/or a spatial shift of the beam centroid of the intermediate beam packet (i.e., the centroid of the intensity distribution over the beam cross section of the entire intermediate beam packet).

The consequence of a change in the angle distribution of the beam segments of the intermediate beam packet (in other words, of a change in the propagation direction of the intermediate beam packet) is that the intermediate beam packet is incident at a changed angle on the transformation lens means that follows the homogenization optical unit in the beam path. Such an angle change at the transformation lens means results, among other things, in a spatial shift of the beam centroid of the output beam. In other words, the beam centroid of the output beam can be spatially shifted by displacing the second lens array in relation to the first lens array. This makes it possible, by way of time-dependent displacement of the second lens array relative to the first lens array, to spatially shift the output beam in dependence on time and to thus smooth disruptive interference effects averaged over time.

A spatial shift of the beam centroid of the intermediate beam packet, on the other hand, has the result that the intermediate beam packet is incident on the transformation lens means at a changed position. Such a spatial shift of the intermediate beam packet results, among other things, in a change in the angle distribution of the beam components of the output beam. In other words, a propagation direction of the output beam is changed by changing the spatial position of the intermediate beam packet.

By way of a time-dependent displacement of the second lens array in relation to the first lens array, regions that lie in the beam path downstream of the optical arrangement (for example further optical means) can in this respect be illuminated from different directions. Contaminations in the beam path downstream of the optical arrangement (for example particulate contaminations on downstream optical means) are consequently likewise illuminated in dependence on time from different directions, with the result that a shadow cast by these contaminations is changed in dependence on time and thus smoothed on average. Inhomogeneities in the intensity profile which are produced by shadows can be reduced in this way. In addition, inhomogeneities resulting from shape inaccuracies of optical units can be reduced.

In summary, such an optical arrangement thus makes it possible to smooth local inhomogeneities in the intensity distribution averaged over time and to thus achieve a significantly improved process result for the surface processing of workpieces.

Preferably, the displacement device is designed to displace the second lens array in relation to the first lens array in a recurring movement pattern. In particular, the time scales of the change in comparison with the process times of the application area of the optical arrangement are so short that effectively a spatially homogeneous intensity is effective along the line direction. Recurring means in particular that an initial configuration will be adopted or cycled through again and again in the manner of an oscillation movement. This oscillation movement can in principle be periodic or non-periodic. It is conceivable that the second lens array is moved back and forth by a reference position. However, a recurring movement preferably does not take place periodically at a fixed frequency, but rather with a varying, in particular randomly varying, frequency and/or amplitude, in particular chaotically. Dominating frequency contributions preferably lie in a range from 50-150 Hz, in particular in a range from 75-125 Hz (in the present context this means in particular that the Fourier spectrum of the movement pattern has a comparatively high amplitude at the so-called dominating frequency contributions).

In order to achieve a particularly homogeneous intensity profile along the line direction, it is preferred if the displacement device is designed to move the second lens array back and forth along the line direction. The beam centroid of the output beam is then likewise moved back and forth along the line direction, that is to say along the long axis. A back-and-forth movement preferably takes place at a varying, in particular randomly varying, frequency, wherein dominating frequency contributions in this case lie in particular in a range from 50-150 Hz, more particularly in a range from 75-125 Hz.

In a preferred configuration, the displacement device comprises a housing frame and a retaining device for retaining the second lens array. The retaining device is shiftably supported in particular at the housing frame. Such a configuration is robust and makes secure retention of the lens array possible even in the case of a comparatively quick displacement. The retaining device is preferably supported at the housing frame in a manner such that it is shiftable back and forth along the line direction.

It is furthermore preferred if the retaining device is supported at the housing frame, for example by way of at least one solid-state bearing. Also conceivable is mounting via roller bearings or by means of air suspension. A bearing makes it possible in principle to displace the retaining device back and forth in an oscillation movement in relation to the housing frame. In this respect, the displacement device is designed such that the retaining device can oscillate back and forth in relation to the housing frame.

In this context it is particularly preferred if a stiffness of the mounting (e.g., of the at least one solid-state bearing) is matched to a frequency of an oscillation movement of the retaining device with respect to the housing frame. However, the stiffness for matching the oscillation movement can also be provided by a separate spring means which couples the retaining device to the housing frame.

For driving a shifting movement of the retaining device, the displacement device preferably comprises an actuator. The actuator can be a motor. The actuator is, for example, a moving coil, a piezo actuator and/or another linear motor.

The transformation lens means is designed in particular to superpose the beam segments mixed by the homogenization optical unit (intermediate beam packet) to form the linear output beam, with the result that the desired linear intensity distribution in the working plane is obtained. For this purpose, the transformation lens means is preferably designed in the form of a refractive Fourier optical unit or of a Fourier lens (in particular one that has no imaging effect). A design in the form of a Fresnel zone plate is conceivable, for example.

As part of a preferred configuration, the first and the second lens array each have a multiplicity of cylindrical lenses extending along respective cylinder axes. For particularly effective mixing of the beam segments in the beam packet, it is advantageous in particular if the cylindrical lenses have geometric dimensions such that the beam packet passes through a multiplicity of cylindrical lenses located one next to the other.

Effective homogenization can be achieved, for example, by virtue of the fact that the respective cylinder axes extend perpendicular to the propagation direction and perpendicular to the line direction. In particular, the cylindrical lenses are designed without curvature along the respective cylinder axis.

The properties of the output beam are also crucially influenced by the design of the reshaping optical unit. The optical processes in the reshaping optical unit are complex and in particular also have an influence on the spatial coherence of the light distribution, which in turn is crucial for the formation of disruptive interference artifacts. The reshaping optical unit is preferably designed such that, when an input laser beam having a high spatial coherence is radiated in through the input aperture, the beam packet emerging from the output aperture has a significantly reduced spatial coherence, in particular is incoherent. In this way, interference effects in the case of the homogenization and/or focusing that follows in the beam path are reduced or entirely avoided, as a result of which inhomogeneities in the intensity profile can be further reduced.

In an embodiment, the present invention provides a laser system which is designed to produce a linear output laser beam having an intensity distribution that has a linear intensity profile in the beam cross section.

The laser system is fed by at least one laser light source to output an input laser beam and comprises an optical arrangement of the previously described type for converting the input laser beam into the linear output beam. The optical arrangement is arranged such that the input laser beam is fed by the laser light source.

The laser light source is suitable or designed in particular for multi-mode operation. The laser radiation of the laser light source can in principle be radiated directly into the optical arrangement. However, it is also conceivable that the laser system furthermore comprises a pre-shaping optical unit, by means of which the laser radiation is reshaped before it enters the optical arrangement. The pre-shaping optical unit may be in the form of a collimation optical unit, for example. For example, the pre-shaping optical unit can have an anamorphic effect, with the result that the input laser beam has an elliptical beam cross section.

In the following description using the figures, the same reference signs are used in each case for identical or corresponding features.

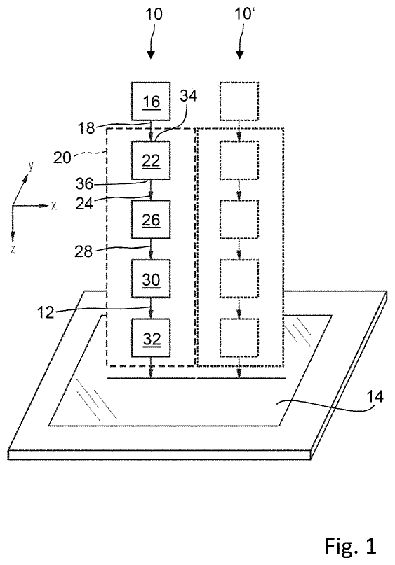

FIG. 1 shows, in a diagrammatic illustration, a laser system 10 for producing an output beam 12, which has in a working plane 14 a linear beam cross section, which is extended along a line direction (x-direction), having a non-vanishing intensity.

The laser system 10 comprises at least one laser light source 16 for outputting laser radiation. The laser light source 16 is preferably designed as a multi-mode laser. The laser radiation provides, optionally via a pre-shaping optical unit (not illustrated), an input laser beam 18. The pre-shaping optical unit can have, for example, a collimating effect and/or reshape the laser radiation into an input laser beam 18 having an elliptical beam cross section. It is conceivable, for example, that the laser radiation is initially reshaped into the input laser beam 18 by means of deflection mirrors and/or lens means.

The laser system 10 furthermore comprises an optical arrangement 20, by means of which the input laser beam 18 is converted into the linear output beam 12.

To explain the geometric relationships, a Cartesian coordinate system (x, y, z) is illustrated in the figures. In the example illustrated, the input laser beam 18 propagates along the z-direction. The axis defined by the linear extent of the output beam 12 extends along the x-axis (“long axis”). An axis perpendicular to the line direction and perpendicular to the propagation direction will be referred to as the “short axis” (y-axis).

It may be desirable for processing large areas to attain a very elongated, linear intensity profile. In this respect, it is conceivable to provide a plurality of laser systems of the type mentioned (10, 10′) and arrange them such that the intensity distributions complement one another to form an elongate line.

The optical arrangement 20 comprises a plurality of optical assemblies, which are arranged one after the other in the beam path. As is illustrated in a simplified manner in FIG. 1, the input laser beam 18 is initially guided through a reshaping optical unit 22, which reshapes the input laser beam 18 into a beam packet 24. The beam packet 24 is subsequently mixed by means of a homogenization optical unit 26 and converted into an intermediate beam packet 28. The intermediate beam packet 28 finally passes through a transformation lens means 30, which is arranged downstream of the homogenization optical unit 26 and converts the intermediate beam packet 28 into the linear output beam 12, which has a substantially homogeneous intensity along the line direction x.

The optical arrangement can optionally additionally comprise a collimation/focusing optical unit 32 arranged in the beam path downstream of the transformation lens means 30.

The reshaping optical unit 22 has an input aperture 34, through which the input laser beam 18 can be coupled in, and an output aperture 36, through which the beam packet 24 emerges. The reshaping optical unit 22 here acts in particular such that adjacent beam segments of the input laser beam 18 are reordered, when they pass through the reshaping optical unit 22, into beam segments of the beam packet 24.

The reshaping optical unit 22 is preferably designed such that, when an input laser beam 18 having a high spatial coherence is radiated in through the input aperture 34, the beam packet 24 emerging from the output aperture 36 has a significantly reduced spatial coherence, in particular is incoherent. For this purpose, the reshaping optical unit 22 can be designed for example such that beam segments of the beam packet 24 emerging from the output aperture 40 have traveled along different optical path lengths in the reshaping optical unit 22. In particular, the differences between the optical path lengths for the beam segments are large in comparison with the coherence length of the laser radiation.

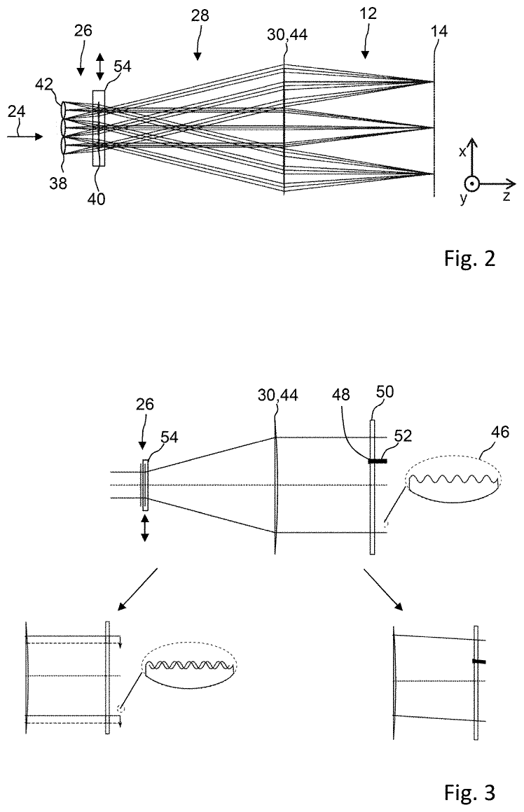

FIG. 2 schematically illustrates the construction and mode of operation of the homogenization optical unit 26 and of the transformation lens means 30. The homogenization optical unit 26 comprises a first lens array 38 and a second lens array 40 arranged downstream of the first lens array in the beam path. As is illustrated by way of example in FIG. 2, the lens arrays 38, 40 each have a multiplicity of cylindrical lenses 42, which extend along respective cylinder axes. The respective cylinder axes in the illustrated example extend orthogonally to the plane of the drawing, that is to say orthogonally to the (local) propagation direction (z) and orthogonally to the (local) line direction (x). The cylindrical lenses 42 are dimensioned geometrically such that the beam packet 24 passes through a multiplicity of the cylindrical lenses 42 that lie one next to the other.

As is evident from FIG. 2, the lens arrays 38, 40 are arranged such that the cylindrical lenses 42 capture the beam packet 24 and mix and superimpose different beam segments of the beam packet 24 with one another. The beam segments which have been mixed and superposed in this way form an intermediate beam packet 28, which in the further progression is incident on the transformation lens means 30 arranged downstream of the homogenization optical unit 26.

The transformation lens means 30 is designed in particular to superpose the beam segments of the intermediate beam packet 28 to form the linear output beam 12, with the result that the desired linear intensity distribution in the working plane 14 is obtained. By way of example and with preference, the transformation lens means 30 is formed by a non-imaging Fourier lens 44. The Fourier lens 44 is arranged in particular such that the working plane 14 extends in a focus plane of the Fourier lens 44 (see FIG. 2).

In particular in combination with the reshaping optical unit 22, which, as was explained above, preferably substantially eliminates the coherence of the input laser beam 18, the mixing and superposition of the beam segments of the beam packet 24 has the effect that the output beam 12 is already comparatively homogeneous along the (local) line direction x. Nevertheless, local inhomogeneities may occur in the intensity profile. For example, it is conceivable that interference effects lead to periodic inhomogeneities in the intensity profile (see detail denoted by the reference sign 46 in FIG. 3). It is furthermore possible that local contaminations in the beam path (for example particles 48 on optical means 50, which are arranged downstream of the Fourier lens 44) cast a shadow 52, which results in a local inhomogeneity in the intensity profile.

As will be explained in detail below, displacement of the second lens array 40 in relation to the first lens array 38 can cause the aforementioned inhomogeneities in the intensity profile to be reduced.

For the displacement of the second lens array 40 in relation to the first lens array 38, the optical arrangement 20 has a displacement device 54 (schematically illustrated in FIGS. 2 and 3). The displacement device 54 is preferably designed to move the second lens array 40 back and forth in relation to the first lens array 38, in particular along the line direction x.

A displacement of the second lens array 40 in relation to the first lens array 38 brings about, among other things, a change in the angle distribution of the beam segments of the intermediate beam packet 28 and/or a spatial shift of the beam centroid of the intermediate beam packet 28.

The consequence of a change in the angle distribution of the beam segments of the intermediate beam packet 28 (in other words, a change in the propagation direction of the intermediate beam packet 28) is that the intermediate beam packet 28 is incident at a changed angle on the Fourier lens 44 that follows the homogenization optical unit 26. Such an angle change at the Fourier lens 44 results in, among other things, a spatial shift of the beam centroid of the output beam 12 (illustrated in dashed lines in FIG. 3, bottom left, by way of example for a displacement of the second lens array “downward”). In this respect, the beam centroid of the output beam 12 can be spatially shifted back and forth by moving the second lens array 40 back and forth in relation to the first lens array 38. In this way, inhomogeneities due to interference effects can be smoothed on average (schematically indicated in FIG. 3, bottom left).

A spatial shift of the beam centroid of the intermediate beam packet 28 has the result that the intermediate beam packet 28 is incident on the Fourier lens 44 at a changed position. Such a shift of the intermediate beam packet 28 has the result, among other things, that specific regions of the Fourier lens 44 receive lesser intensity contributions of the intermediate beam packet 28, as a result of which the light distribution of the output beam 12 attains a preferential angle or an asymmetry (indicated in FIG. 3, bottom right, by way of example for a shift of the intermediate beam packet 28 “upward” from a central reference position). In this respect, a propagation direction of the output beam 12 can be changed in dependence on time by moving the second lens array 40 back and forth in relation to the first lens array 38. This has the result that contaminations 48 (for example dust particles) in the beam path downstream of the Fourier lens 44 (for example on an optical unit 52 that follows) are illuminated in dependence on time from different directions. A shadow 52 produced by such contamination 48 is in this respect likewise changed temporally, with the result that a disruptive influence of the shadow on the intensity profile can be smoothed on average.

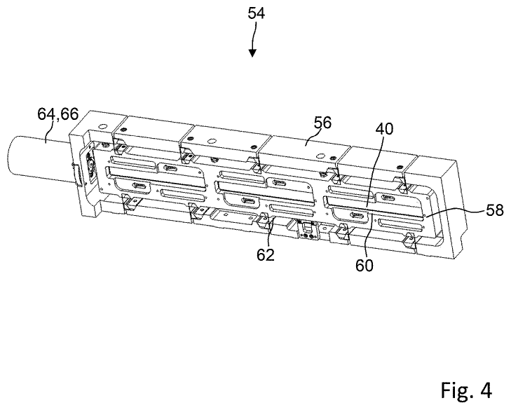

FIG. 4 shows a preferred configuration of the displacement device 54.

The displacement device 54 comprises a housing frame 56 and a retaining device 58 for retaining the second lens array 40. The retaining device 58 has, in certain regions, cutouts 60, which serve as windows for transmitting the laser beam through the lens array 40.

The retaining device 58 is supported at the housing frame 56 via a bearing device 62 (comprising for example a plurality of solid-state bearings), with the result that the retaining device 58 can oscillate back and forth in relation to the housing frame 56. It is preferred here if a bearing stiffness of the bearing device 62 is matched to a frequency of an oscillation movement of the retaining device 58 with respect to the housing frame 56.

In order to drive an oscillation movement of the retaining device 58 in relation to the housing frame 56, the displacement device furthermore has an actuator 64, which is designed by way of example and with preference as a moving coil 66.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An optical arrangement for converting an input laser beam into a linear output beam propagating along a propagation direction and having in a working plane and a linear beam cross section extending along a line direction and having a non-vanishing intensity,
the optical arrangement comprising:
a reshaping optical unit having an input aperture for receiving the input laser beam and an output aperture,
wherein the reshaping optical unit is configured to convert the input laser beam into a beam packet having a multiplicity of beam segments that emerges through the output aperture;
a homogenization optical unit having a first lens array and a second lens array arranged downstream of the first lens array in the beam path, the homogenization optical unit configured to mix different beam segments of the beam packet along the line direction,
a transformation lens configured such to superpose the mixed beam segments so as to form the linear output beam, and
a displacement device configured to displace the second lens array relative to the first lens array.

2. The optical arrangement as claimed in claim 1, wherein the displacement device is configured to move the second lens array relative to the first lens array in a recurrent movement pattern.

3. The optical arrangement as claimed in claim 1, wherein the displacement device is configured to move the second lens array back and forth along the line direction.

4. The optical arrangement as claimed claim 1, wherein the displacement device comprises a housing frame and a retaining device for retaining the second lens array, wherein the retaining device is shiftably supported at the housing frame.

5. The optical arrangement as claimed in claim 4, wherein the retaining device is supported at the housing frame via a bearing device.

6. The optical arrangement as claimed in claim 5, wherein a bearing stiffness of the bearing device is matched to a frequency of an oscillation movement of the retaining device with respect to the housing frame.

7. The optical arrangement as claimed in claim 4, further comprising a spring means coupling the retaining device to the housing frame.

8. The optical arrangement as claimed in claim 4, wherein the displacement device comprises an actuator for driving a shift movement of the retaining device.

9. The optical arrangement as claimed in claim 1, wherein the at least one transformation lens means is in the form of a Fourier lens.

10. The optical arrangement as claimed in claim 1, wherein each of the first and the second lens array have a multiplicity of cylindrical lenses extending along respective cylinder axes.

11. The optical arrangement as claimed in claim 10, wherein the respective cylinder axes extend perpendicular to the propagation direction and perpendicular to the line direction.

12. The optical arrangement as claimed in claim 1, wherein the reshaping optical unit is configured such that, when an input laser beam having a high spatial coherence is radiated in through the input aperture, the beam packet emerging from the output aperture has a significantly reduced spatial coherence.

13. The optical arrangement as claimed in claim 2, wherein the recurrent movement pattern is periodically recurrent.

14. The optical arrangement as claimed in claim 8, wherein the actuator includes a moving coil or a piezo actuator.

15. The optical arrangement as claimed in claim 10, wherein the multiplicity of cylindrical lenses are geometrically dimensioned such that the beam packet passes through the multiplicity of cylindrical lenses located one next to the other.

16. The optical arrangement as claimed in claim 11, wherein the cylindrical lenses are formed without curvature along a respective curvature axis.

17. The optical arrangement as claimed in claim 12, wherein the beam packet emerging from the output aperture is incoherent.

18. A laser system for producing a linear output beam having an intensity distribution which has a linear intensity profile in the beam cross section, comprising:
at least one laser light source for outputting an input laser beam;
an optical arrangement as claimed in claim 1 for converting the input laser beam into the linear output beam.
